(19) United States
(12) Patent Application Publication
(10) Pub. No.: US 2026/0030716 A1
(43) Pub. Date: Jan. 29, 2026

(54) DISTRIBUTED COMMUNICATION SYSTEM

(71) Applicant: Applied Materials Israel Ltd., Rehovot (IL)

(72) Inventors: Alexander Bronepolscy, Rehovot (IL); Dmitry Grebenyuk, Rehovot (IL)

(73) Assignee: Applied Materials Israel Ltd., Rehovot (IL)

(21) Appl. No.: 18/787,867

(22) Filed: Jul. 29, 2024

(51) Int. Cl. G06T 1/60; G06V 10/141

(52) U.S. Cl. CPC G06T 1/60; G06V 10/141

(57) ABSTRACT

A system for distributed communication, the system includes an imager configured to illuminate a sample and provide an image; multiple groups of boards, comprising (i) multiple groups of board memory units, each board memory unit is configured to store the image, (ii) multiple groups of arrays of image processing circuits having image processing circuits memory units; (iii) housings, wherein different group of boards are located within different housings; and (iv) multiple communication units that participate in imposing a conflict free communication scheme related to a provision of the image portions from the image processing circuits to a memory unit associated with the control unit; the conflict free communication scheme limits a maximal number of concurrently open communication sessions with image processing circuits of each board.

### BACKGROUND OF THE INVENTION

Samples such as semiconductors are evaluated by charged particles systems.

Examples of a charged particle system include (i) a defect review scanning electron microscope SEMVISION™ of APPLIED MATERIALS™ Inc. of San Jose, California, (ii) a metrology system such as the PROVision™ 3E Ebeam™ metrology system of APPLIED MATERIALS™, (iii) an electron beam inspection system such as the PRIMEVISION™ of APPLIED MATERIALS™, or (iv) a critical dimension scanning electron microscope such as the VERITYSEM™ of APPLIED MATERIALS™, and the like. The charge particle system may be manufactured by vendors such as HITACHI™ of Tokyo, Japan, or KLA™ Corporation of Milpitas, California, or may be manufactured by other vendors.

Images generated by a charged particle system exhibit extremely fine resolution and are extremely large.

The outputting of such images from the charged particle system requires extensive bandwidths and may result in communication contentions and in a highly ineffective communication process.

There is a growing need to provide a highly effective solution for effectively outputting such images from a charged particle system.

### BRIEF SUMMARY OF THE INVENTION

There is provided a system, a method and a non-transitory computer readable medium that stores instructions executable by a system for distributed communication. In some embodiments the system includes an imager configured to illuminate a sample and provide an image; and multiple groups of boards, including (i) multiple groups of board memory units, each board memory unit configured to store the image, (ii) multiple groups of arrays of image processing circuits having image processing circuits memory units; (iii) housings, wherein different group of boards are located within different housings; and (iv) multiple communication units that participate in imposing a conflict free communication scheme related to a provision of the image portions from the image processing circuits to a memory unit associated with the control unit. In some embodiments the conflict free communication scheme can limit a maximal number of concurrently open communication sessions with image processing circuits of each board.

### BRIEF DESCRIPTION OF THE DRAWINGS

The subject matter regarded as the invention is particularly pointed out and distinctly claimed in the concluding portion of the specification. The invention, however, both as to organization and method of operation, together with specimen s, features, and advantages thereof, may best be understood by reference to the following detailed description when read with the accompanying drawings in which:

FIG. 1 illustrates an example of a system and external elements;

FIG. 2 illustrates an example of a method; and

FIG. 3 illustrates an example of a method.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

According to an embodiment, a system such as a charged particle system includes groups of arrays of image processing circuits having image processing circuits memory units. The system may be required to output an image to a control unit located outside the system using a communication infrastructure that is not capable of outputting all image segments concurrently.

According to an embodiment the control unit is a computerized system that also includes (or is in communication with) a memory unit and processing resources such as processing circuits. The computerized system may be a server, a cloud computing environment, a computer, and the like.

According to an embodiment, the communication infrastructure is designed to output, from the groups of arrays of image processing circuits, processing results regarding the image portions, the processing results are more compact than the image portions. Examples of processing results include defects, suspected defects, measurements, and the like.

An image portion may include any subsets of image pixels-for example, a row of an image, a sequence of rows of the image, a part of a row, a column of the image, a sequence of columns of an image, and the like.

According to an embodiment, the system is configured to operate at a first mode that requires the outputting of the image portions and at a second mode that requires the outputting of the processing results.

According to an embodiment, the system is configured to operate only in the first mode.

According to an embodiment, the system is configured to operate only in the second mode.

According to an embodiment, the selection between the modes is made by a user of the system, or any other entity and the system or the control unit is informed about the mode.

According to an embodiment, the selection between the modes is done based on the resources available for performing the processing. If the processing requires more resources than those available by the system, then the first mode is selected.

According to an embodiment, the image portions are outputted to a memory unit associated with a control unit for processing.

According to an embodiment, the groups of arrays of image processing circuits and the control unit participate in the processing of the image portions, and the groups of arrays of image processing circuits output at least partially processed image portions.

According to an embodiment, the control unit controls the communication process and also the allocation of image portions to the groups of arrays of image processing circuits.

According to an embodiment, allowing the control unit control the allocation of image portions to the image processing circuits, and control the transmission of image portions offloads the system from performing such tasks and allows the control unit to align the communication with the processing of the image portions executed by the control unit or with any other computational resource outside the system that is accessible by the control unit.

According to an embodiment, there is provided a highly effective communication method for outputting image portions from a charged particle system.

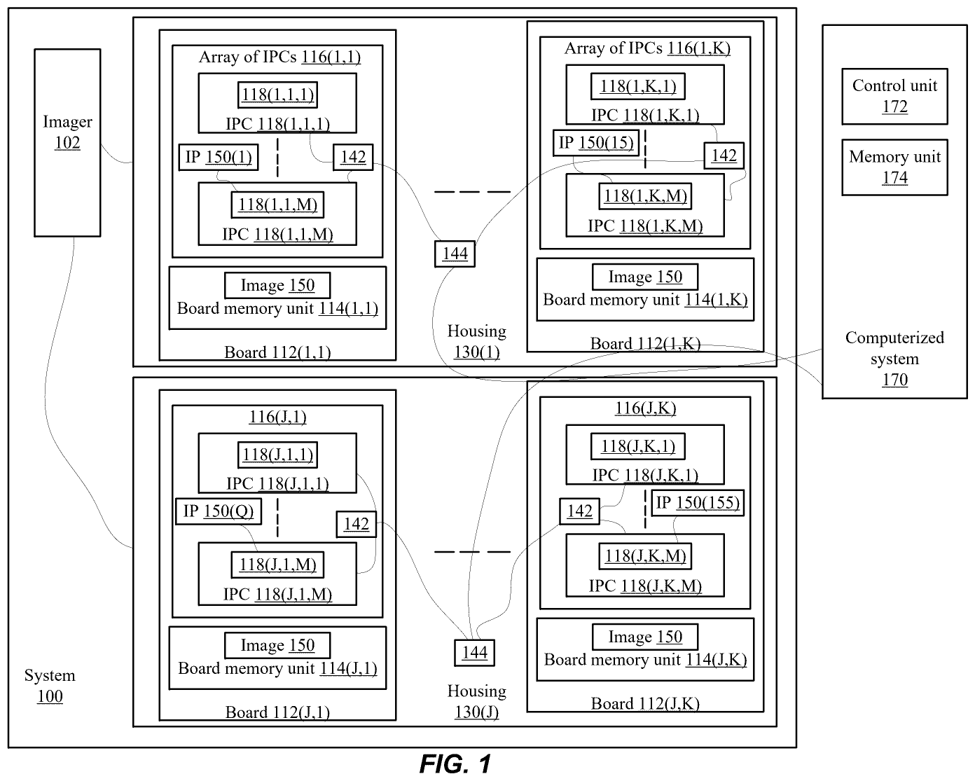

FIG. 1 illustrates an example of a system 100 for distributed communication and a computerized system 170 that includes control unit 172 and memory unit 174 that is associated with the control unit.

System 100 includes an imager, multiple groups of boards, housings, and communication units.

Imager 102 is configured to illuminate a sample and provide an image. The imager may be a charged particle imager configured to illuminate the sample with charged particles, and to detect particles or photons emitted from the sample due to an illumination.

There are J groups of boards 110 (1)-110 (J), J being a positive integer. Each group of boards includes K boards 112 (1,1)-112 (j,K), j ranges between 1 to J and K being a positive integer.

The (j,k) th board 112 (j,k) includes:
a. A (j,k)'th board memory unit 114 (j,k) that is configured to store the image 150—so that the multiple groups of boards store JxK duplicates of the image.
b. An array 116 (j,k) of image processing circuits 118 (j,k,1)-118 (j,k,M) having image processing circuits memory units 120 (j,k,1)-120 (j,k,M).

Accordingly, the multiple groups of boards include:
a. Multiple groups of board memory units 114 (1,1)-114 (J,K).
b. Multiple groups of arrays 116 (1,1)-116 (J,K) of image processing circuits 118 (1,1,1)-118 (J,K,M) having image processing circuits memory units 120 (1,1,1)-120 (J,K,M).

Housings 130 (1)-130 (J), wherein different group of boards are located within different housings. The housing may provide at least one of a mechanical support to the bords, provision of power to the boards, provide communication within the housing and outside the housing, and provide mechanical protection to the boards.

Communication units that are illustrated in FIG. 1 as including board communication units 142 and are for board to housing communication, and housing communication units 144 configured to communicate with a control unit communication unit.

FIG. 1 also illustrates various image processing circuits memory units as storing various Q image portions such as IP 150 (1), IP 150 (15), IP 150 (Q), and IP 150 (155). The communication units are configured, while the system operates in a first mode, to:
a. Receive from a control unit, an allocation of image portions to image processing circuits of the multiple groups of arrays of image processing circuits.
b. Convey the allocation to the of image portions to the image processing circuits.
c. Receive from a control unit, communication control instructions for imposing a conflict free communication scheme related to a provision of the image portions from the image processing circuits memory units to a memory unit associated with the control unit. A communication control instructions may be a request to send an image portion downstream towards the memory unit associated with the control unit.
d. Send the communication control instructions to the image processing circuits.
e. Receive image portions from the image processing circuits.
f. Send the image portions to the memory unit associated with the control unit.

According to an embodiment, the image processing circuits are configured to transmit, while the system operates in a first mode, the image portions according to the communication control instructions thereby following the conflict free communication scheme.

According to an embodiment, the system is configured to apply the conflict free communication scheme related to a provision of the image portions from the image processing circuits memory units to a memory unit associated with the control unit.

According to an embodiment, the conflict free communication scheme applies limitations on the maximal number of concurrently open communication sessions with image processing circuits of each board.

According to an embodiment, the conflict free communication scheme also applies limitations on the maximal number of concurrently open communication sessions with image processing circuits of a housing. This assists in solving communication conflicts-when most or all of the digital processing circuits are included in one housing-or in other case where the active digital processing unit are not properly distributed between the housings.

The maximal number of concurrently open communication sessions with image processing circuits of each board is defined so that if all boards comply with this limitation, there are no conflicts, given the communication resources of the image processing circuits, the boards, the housing, and the system.

According to an embodiment, each array of image processing circuits includes tens of image processing circuits, and each group of boards comprises tens of boards.

For example, assuming that there are 24 image processing circuits per board, there are 2 housings (2 groups of boards), each group includes 20 boards, and that each image processing circuit is configured to transmit at a rate of 100 Mega bits per second (Mbs). Concurrent transmission of image portions at the rate of 100 Mbs will result in 9.6 Giga bits per second (Gbs)-which well exceeds the communication capability of each board and of each housing.

According to an embodiment, the image processing circuits of group of boards within a housing are configured communicate with the control unit communication unit via a housing communication unit of the housing and via boards communication units of the group of boards.

According to an embodiment, the system operates in a second mode in which the image processing circuits process the image portions to provide processing results regarding the image portions, and the system imposes a conflict free communication scheme related to a provision of the processing results regarding the image portions from the image processing circuits to the memory unit associated with the control unit.

According to an embodiment, the processing results are much smaller than the image portions, and the traffic per image processing circuit is much smaller-so that more image processing circuits may concurrently transmit their processing results.

According to an embodiment, the communication units are further configured to convey to the image processing circuits commands to start processing the image portions.

According to an embodiment, the communication units are further configured to convey, to the control unit image, indications about processing circuits end of processing.

According to an embodiment, the system is configured to receive from the control unit a mode instruction that determines a mode of operation of the system out of the first mode and the second mode.

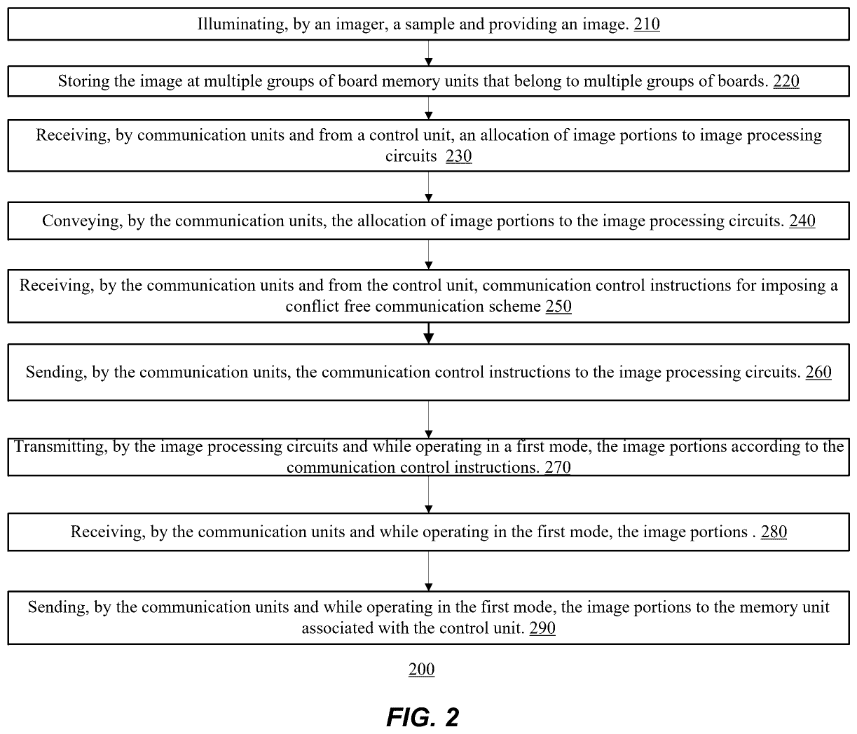

FIG. 2 illustrates a method 200 for distributed communication.

According to an embodiment, method 200 starts by step 210 of illuminating, by an imager, a sample and providing an image.

According to an embodiment, step 210 is followed by step 220 of storing the image at multiple groups of board memory units that belong to multiple groups of boards, the multiple groups of board also comprise multiple groups of arrays of image processing circuits having image processing circuits memory units; wherein different group of boards are located within different housings.

According to an embodiment, step 220 is followed by step 230 of receiving, by communication units and from a control unit, an allocation of image portions to image processing circuits of the multiple groups of arrays of image processing circuits.

According to an embodiment, step 230 is followed by step 240 of conveying, by the communication units, the allocation of image portions to the image processing circuits.

According to an embodiment, step 240 is followed by step 250 receiving, by the communication units and from the control unit, communication control instructions for imposing a conflict free communication scheme related to a provision of the image portions from the image processing circuits to a memory unit associated with the control unit. The conflict free communication scheme limits a maximal number of concurrently open communication sessions with image processing circuits of each board.

According to an embodiment, step 250 is followed by step 260 of sending, by the communication units, the communication control instructions to the image processing circuits.

According to an embodiment, step 260 is followed by step 270 of transmitting, by the image processing circuits and while operating in a first mode, the image portions according to the communication control instructions thereby following the conflict free communication scheme.

According to an embodiment, step 270 is followed by step 280 of receiving, by the communication units and while operating in the first mode, the image portions from the image processing circuits.

According to an embodiment, step 280 is followed by step 290 of sending, by the communication units and while operating in the first mode, the image portions to the memory unit associated with the control unit.

According to an embodiment, the conflict free communication scheme further limits a maximal number of concurrently open communication sessions with image processing circuits of a housing.

According to an embodiment, method 200 is limited to operating the system at the first mode.

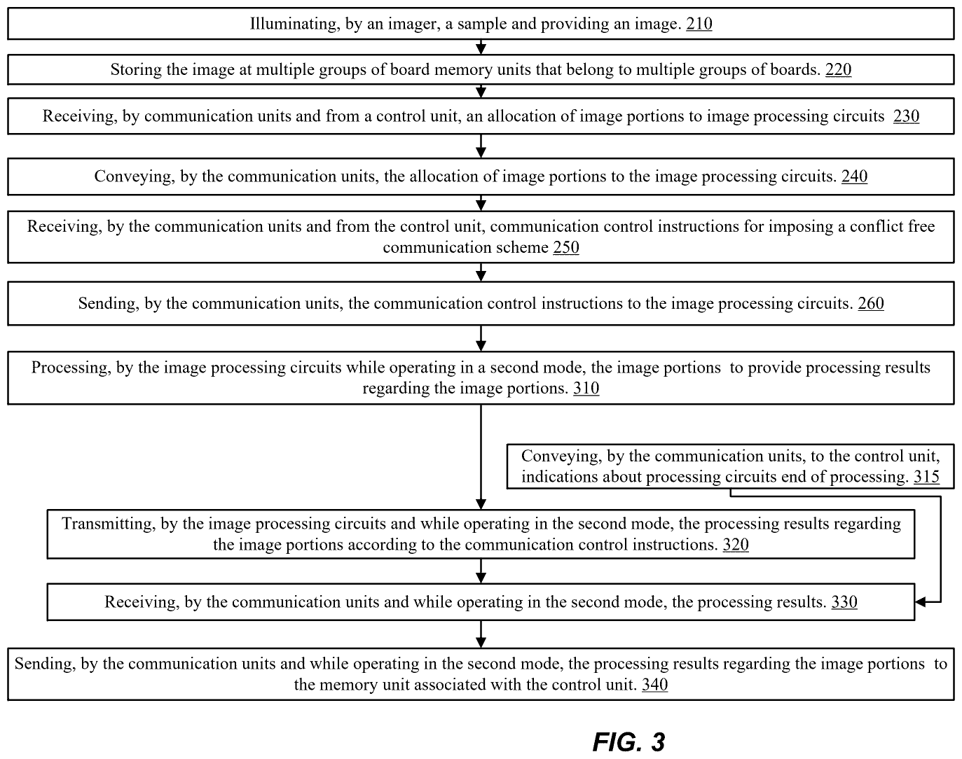

FIG. 3 illustrates an example of method 300 that is applicable for the second mode of operation.

According to an embodiment, method 300 starts by steps 210, 220, 230, 240, 250 and 260.

According to an embodiment, step 260 is followed by step 310 of processing, by the image processing circuits while operating in a second mode, the image portions to provide processing results regarding the image portions.

According to an embodiment, step 310 is followed by step 320 of transmitting, by the image processing circuits and while operating in the second mode, the processing results regarding the image portions according to the communication control instructions thereby following the conflict free communication scheme.

According to an embodiment, step 320 is followed by step 330 of receiving, by the communication units and while operating in the second mode, the processing results regarding the image portions from the image processing circuits.

According to an embodiment, step 330 is followed by step 340 of sending, by the communication units and while operating in the second mode, the processing results regarding the image portions to the memory unit associated with the control unit.

According to an embodiment, step 340 is preceded by conveying, by the communication units, to the image processing circuits commands to start processing the image portions.

According to an embodiment, step 330 is preceded by step 315 of conveying, by the communication units, to the control unit, indications about processing circuits end of processing.

According to an embodiment, methods 200 and 300 are combined to support the first mode and the second mode.

In the foregoing detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using mechanical components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any reference to comprising or having or including or includes or includes or include or have should be applied mutatis mutandis to consisting or consists of.

Any reference to comprising or having or including or includes or include or have should be applied mutatis mutandis to consisting essentially of.

The term and/or means additionally or alternatively. For example A and/or B means only A, or only B or A and B.

In the foregoing specification, the embodiments of the disclosure have been described with reference to specific examples of embodiments. It will, however, be evident that various modifications and changes may be made therein without departing from the broader spirit and scope of the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for distributed communication, the system comprising:
an imager configured to illuminate a sample and provide an image;
multiple groups of boards, comprising (i) multiple groups of board memory units, each board memory unit is configured to store the image, and (ii) multiple groups of arrays of image processing circuits having image processing circuits memory units;
housings, wherein different group of boards are located within different housings; and
communication units configured to, while the system operates in a first mode:
(i) receive from a control unit, an allocation of image portions to image processing circuits of the multiple groups of arrays of image processing circuits;
(ii) convey the allocation to the of image portions to the image processing circuits;
(iii) receive from a control unit, communication control instructions for imposing a conflict free communication scheme related to a provision of the image portions from the image processing circuits memory units to a memory unit associated with the control unit; the conflict free communication scheme limits a maximal number of concurrently open communication sessions with image processing circuits of each board;
(iv) send the communication control instructions to the image processing circuits;
(v) receive image portions from the image processing circuits; and
(vi) send the image portions to the memory unit associated with the control unit;
wherein the image processing circuits are configured to transmit, while the system operates in a first mode, the image portions according to the communication control instructions thereby following the conflict free communication scheme.

2. The system according to claim 1, wherein the communication units comprise boards communication units and housing communication units configured to communicate with a control unit communication unit.

3. The system according to claim 2, wherein image processing circuits of group of boards within a housing are configured communicate with the control unit communication unit via a housing communication unit of the housing and via boards communication units of the group of boards.

4. The system according to claim 1, wherein each array of image processing circuits comprises tens of image processing circuits, and wherein each group of boards comprises tens of boards.

5. The system according to claim 1, wherein the conflict free communication scheme further limits a maximal number of concurrently open communication sessions with image processing circuits of a housing.

6. The system according to claim 1, wherein the image processing circuits are configured to process image portions to provide processing results regarding the image portions, when the system operates in a second mode; and
wherein the system is configured to impose a conflict free communication scheme related to a provision of the processing results regarding the image portions from the image processing circuits to the memory unit associated with the control unit.

7. The system according to claim 6, wherein the communication units are further configured to convey to the image processing circuits commands to start processing the image portions.

8. The system according to claim 6, wherein the communication units are further configured to convey, to the control unit, indications about processing circuits end of processing.

9. The system according to claim 6, wherein the system is configured to receive from the control unit a mode instruction that determines a mode of operation of the system out of the first mode and the second mode.

10. A method for distributed communication, the method comprising:
illuminating, by an imager, a sample and providing an image;
storing the image at multiple groups of board memory units that belong to multiple groups of boards, the multiple groups of board also comprise multiple groups of arrays of image processing circuits having image processing circuits memory units; wherein different group of boards are located within different housings;
receiving, by communication units and from a control unit, an allocation of image portions to image processing circuits of the multiple groups of arrays of image processing circuits;
conveying, by the communication units, the allocation of image portions to the image processing circuits;
receiving, by the communication units and from the control unit, communication control instructions for imposing a conflict free communication scheme related to a provision of the image portions from the image processing circuits to a memory unit associated with the control unit; the conflict free communication scheme limits a maximal number of concurrently open communication sessions with image processing circuits of each board;
sending, by the communication units, the communication control instructions to the image processing circuits;
transmitting, by the image processing circuits and while operating in a first mode, the image portions according to the communication control instructions thereby following the conflict free communication scheme;
receiving, by the communication units and while operating in the first mode, the image portions from the image processing circuits; and
sending, by the communication units and while operating in the first mode, the image portions to the memory unit associated with the control unit.

11. The method according to claim 10, wherein the communication units comprise boards communication units and housing communication units configured to communicate with a control unit communication unit.

12. The method according to claim 10, wherein the conflict free communication scheme further limits a maximal number of concurrently open communication sessions with image processing circuits of a housing.

13. The method according to claim 10, further comprising:
processing, by the image processing circuits while operating in a second mode, the image portions to provide processing results regarding the image portions;
transmitting, by the image processing circuits and while operating in the second mode, the processing results regarding the image portions according to the communication control instructions thereby following the conflict free communication scheme;
receiving, by the communication units and while operating in the second mode, the processing results regarding the image portions from the image processing circuits; and
sending, by the communication units and while operating in the second mode, the processing results regarding the image portions to the memory unit associated with the control unit.

14. The method according to claim 13, further comprising conveying, by the communication units, to the image processing circuits commands to start processing the image portions.

15. The method according to claim 13, further comprising conveying, by the communication units, to the control unit, indications about processing circuits end of processing.

16. A non-transitory computer readable medium for distributed communication, the non-transitory computer readable medium stores instructions executable by a system for:
illuminating, by an imager, a sample and providing an image;
storing the image at multiple groups of board memory units that belong to multiple groups of boards, the multiple groups of board also comprise multiple groups of arrays of image processing circuits having image processing circuits memory units; wherein different group of boards are located within different housings;
receiving, by communication units and from a control unit, an allocation of image portions to image processing circuits of the multiple groups of arrays of image processing circuits;
conveying, by the communication units, the allocation of image portions to the image processing circuits;
receiving, by the communication units and from the control unit, communication control instructions for imposing a conflict free communication scheme related to a provision of the image portions from the image processing circuits to a memory unit associated with the control unit; the conflict free communication scheme limits a maximal number of concurrently open communication sessions with image processing circuits of each board;
sending, by the communication units, the communication control instructions to the image processing circuits;
transmitting, by the image processing circuits and while operating in a first mode, the image portions according to the communication control instructions thereby following the conflict free communication scheme;
receiving, by the communication units and while operating in the first mode, the image portions from the image processing circuits; and
sending, by the communication units and while operating in the first mode, the image portions to the memory unit associated with the control unit.

17. The non-transitory computer readable medium according to claim 16, wherein the conflict free communication scheme further limits a maximal number of concurrently open communication sessions with image processing circuits of a housing.

18. The non-transitory computer readable medium according to claim 16, further storing instructions executable by a system for:
processing, by the image processing circuits while operating in a second mode, the image portions to provide processing results regarding the image portions;
transmitting, by the image processing circuits and while operating in the second mode, the processing results regarding the image portions according to the communication control instructions thereby following the conflict free communication scheme;
receiving, by the communication units and while operating in the second mode, the processing results regarding the image portions from the image processing circuits; and
sending, by the communication units and while operating in the second mode, the processing results regarding the image portions to the memory unit associated with the control unit.
